(19) United States
(12) Patent Application Publication
(10) Pub. No.: US 2019/0043475 A1
(43) Pub. Date: Feb. 7, 2019

(54) Spoken Language Localization System

(71) Applicant: Walmart Apollo, LLC, Bentonville, AR (US)

(72) Inventors: Steven Jackson Lewis, Bentonville, AR (US); Matthew Dwain Biermann, Fayetteville, AR (US); Suman Pattnaik, Bentonville, AR (US)

(21) Appl. No.: 16/054,060

(22) Filed: Aug. 3, 2018

Related U.S. Application Data
(60) Provisional application No. 62/541,393, filed on Aug. 4, 2017.

(51) Int. Cl. G10L 15/00; G06F 17/27; G06F 21/32

(52) U.S. Cl. CPC G10L 15/005; G06F 21/32; G06F 17/2705; G06F 17/275

(57) ABSTRACT

Spoken language localization systems and methods are described. A spoken language localization system receives samples from one or more audio sensors that detect speech of an opted-in individual in proximity to a computing device, parses the samples, identifies the parsed samples as an identified language using the language rules engine and at least one language database, determines whether the identified language corresponds to a language listed in a user account, and automatically localizes the application to the identified language on the computing device based on determining that the identified language corresponds to a language listed in a user account of a user associated with the computing device.

### RELATED APPLICATION

This application claims priority to, and the benefit of, U.S. Provisional Patent Application No. 62/541,393 entitled “Spoken Language Localization System”, filed Aug. 4, 2017, the contents of which are incorporated herein in their entirety.

### BACKGROUND

Audio sensors can detect a variety of sounds including human speech. The detected speech data acquired by the audio sensors may be parsed for further analysis. The parsed speech may be processed to identify a language spoken by the speaker.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a block diagram showing a spoken language localization system in accordance with an exemplary embodiment.

FIG. 2 is a flow diagram illustrating a method performed by a spoken language localization system in accordance with an exemplary embodiment.

FIG. 3 is a flow diagram illustrating a method performed by a spoken language localization system in accordance with another exemplary embodiment.

FIG. 4 is a block diagram of an exemplary computational device with various components which can be used to implement various embodiments.

FIG. 5 is block diagram of an exemplary distributed system suitable for use in exemplary embodiments.

FIG. 6 is a flowchart depicting a sequence for performing application localization in an exemplary embodiment.

### DETAILED DESCRIPTION

Methods and systems are provided herein for localizing applications executed on a computing device according to a language spoken by an individual in the vicinity of a computing device who has given consent to their language being detected by audio sensors and integrated into the spoken language localization system. The spoken language localization system, in accordance with various embodiments, is configured to receive speech samples of the individual from audio sensors (after the individual has opted-in to having the speech detected), parse the speech samples, identify the parsed samples as an identified language using a language rules engine and at least one language database, determine whether the identified language corresponds to a language listed in a user account of a user associated with the computing device, and localize the application to the identified language on the computing device without user intervention based on determining that the identified language corresponds to one of the one or more different languages listed in the user account for the user.

In one embodiment, the spoken language localization system can identify which language is spoken by an individual near the user and the computing device and automatically change the language of the executed application to the identified language without the user of the computing device or the individual being involved.

For example, in one embodiment, in a facility such as a retail location, the audio sensors located in the facility, such as audio sensors located near a the point-of-sale (POS) device, can detect a language spoken by an individual, such as a customer, who is speaking in the proximity of the POS device and who has previously opted-in to the localization service. For example, the individual may opt-in to the localization feature via a registration process for a mobile application associated with the facility that executes on the individual's phone or other mobile device. After identifying the language, the spoken language localization system determines whether this detected language is one of the languages spoken by the user of the POS device, such as a cashier or other store associate, by consulting a user account that includes a listing of languages with which the user is fluent or at least conversant as previously reported by the user. If the detected language is also spoken by the user associated with the POS device then the spoken language localization system can localize (i.e. switch) the language currently used at the POS device to the detected language to make interactions easier for the individual. For example, a user interface provided by the application may be switched to display in a language with which both the individual/customer and the user/associate are comfortable.

In another embodiment, in a facility such as a retail location, a mobile application provided by the facility is executing on a mobile device, such as a smartphone, and audio sensors are located in the mobile device. When the user of the mobile device is talking to another individual, such as a customer or a facility associate who has opted-in to the localization feature, if the spoken language localization system detects a language different than the default language of the mobile application, and if the user of the mobile device also speaks the detected language (based on the user's profile when registering or installing the mobile application), the spoken language localization system can localize the language used at the mobile device to the detected language to make interaction easier between the user and the individual. In this scenario, the opt-in may be detected by an automatic query between the user's mobile device and the other individual's mobile device to determine opt-in status before beginning audio detection.

Accordingly, systems and methods provided herein allow the spoken language localization system to detect a language spoken by a nearby individual who has opted-in to the localization feature and localize the application executed on a computing device to the detected language if the user also is fluent or at least comfortable in the detected language (as previously specified by the user). In facilities located in geographic regions with customers speaking many languages, the spoken language localization system provides a seamless and automatic transition to application displays that are generated in a language that is appropriate for both the nearby individual and the user of the computing device.

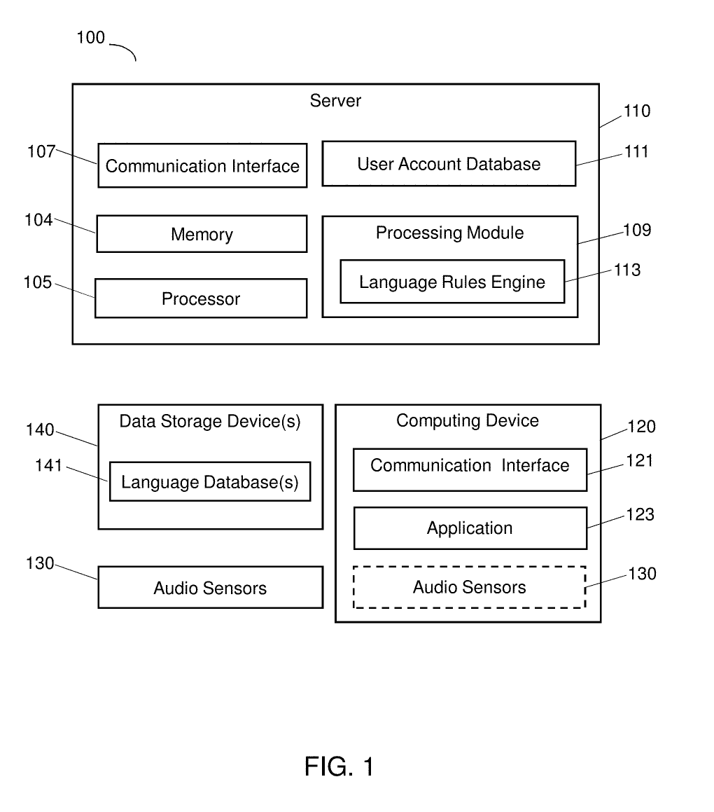

Referring now to FIG. 1, an exemplary spoken language localization system 100 includes a server 110, a computing device 120, audio sensors 130, and data storage device(s) 140. The server 110 includes memory 104, a processor 105 and communication interface 107. The server is configured to execute an analysis module 109 and also includes or is able to access a user account database 111.

The computing device 120 includes communication interface 121 for communicating with the server 110 and executes an application 123. In one embodiment, the computing device 120 may be a point-of-sale (POS) system of a facility such as a retail location, and the audio sensors 130 may be located in a proximity of the computing device, such that the audio sensors 130 can detect speech of opted-in individuals in the proximity of the computing device, acquire samples of the detected speech, and transmit the acquired samples via communication interface 121 to analysis module 109 on server 110.

In another embodiment, the computing device 120 may be a mobile device operated by a user, such as smartphone, tablet or other mobile device equipped with a processor, mobile application 123 and communication interface 121. The audio sensors 130 can be located in the computing device 120, i.e., the mobile device in this embodiment, such that the audio sensors 130 can detect speech of opted-in individuals in the proximity of the mobile device, acquire samples of the detected speech, and transmit the acquired samples via communication interface 121 to analysis module 109 on server 110. Alternatively, in one embodiment, the audio sensors 130 may be audio sensors located in the facility within range of the computing device 120, the user and the individual in proximity to the computing device.

The user account database 111 includes information associated with user accounts, such as the user's profile, which includes the languages that the user speaks. It will be appreciated that as this information is self-reported by the user it may represent a listing of languages that the user is fluent in or merely conversant. In one embodiment the application 123 can generate a user interface for accepting user input including the language information for the user account and is configured to acquire identification information of a user account. The application 123 transmits the acquired identification information of the user account via communication interface 121 to analysis module 109 on server 110, and the server can access the user account database 111 using the received identification information and acquire the information about the languages spoken by the user.

The data storage device(s) 140 can hold language database(s) 141 containing audio samples of different languages and language dialects. Analysis module 109 includes a language rules engine 113 that parses speech samples received from the audio sensors and identifies the parsed samples as an identified language using the language database(s) 141. When the identified language is determined to correspond to a language also spoken by the user that is listed in the user account, the analysis module can localize the application 123 to the identified language on the computing device 120 without user intervention by transmitting a command to the application to make the change in language.

Communication interface 107, in accordance with various embodiments can include, but is not limited to, a radio frequency (RF) receiver, RF transceiver, NFC device, a built-in network adapter, network interface card, PCMCIA network card, card bus network adapter, wireless network adapter, USB network adapter, modem or any other device suitable for interfacing with any type of network capable of communication and performing the operations described herein. Processor 105, in accordance with various embodiments can include, for example, but not limited to, a microchip, a processor, a microprocessor, a special purpose processor, an application specific integrated circuit, a microcontroller, a field programmable gate array, any other suitable processor, or combinations thereof. Server 110 may also include, memory (not shown) such as but not limited to, hardware memory, non-transitory tangible media, magnetic storage disks, optical disks, flash drives, computational device memory, random access memory, such as but not limited to DRAM, SRAM, EDO RAM, any other type of memory, or combinations thereof.

For example, if a facility associate speaks more than one language, for example, languages X and Y, and these two languages are listed in the user's profile associated with the user account. When the facility associate logs into his/her account on a computing device such as a POS device in a facility such as a retail location, the applications executed on the POS device are in one of the two languages X and Y spoken by the facility associate. For example, the interface and the content of the applications may be displayed in language X. When another individual, such as a customer is in the proximity of the POS device, the audio sensors may detect a language other than X being spoken by the individual. The spoken language localization system, using the language rules engine and the languages database, parses the speech samples received from the audio sensors and identifies the detected language as language Y. Based on the user profile in the user account of the facility associate, the computing system determines that language Y is one of the two languages spoken by the facility associate, and the applications executed on the POS device can be automatically localized to language Y. For example, the POS device may be configured to accept a command from a remote server in the spoken language localization system to switch the language. In contrast, if the detected language is identified by the spoken language localization system as language Z, which is not spoken by the facility associate, the application will not be localized to language Z.

In another example, a user A may be operating a mobile computing device equipped with a mobile application. As part of a registration process for the application, the user A may be asked to list languages with which they have a degree of proficiency as part of establishing a user profile. Alternatively, if the mobile computing device is provided by the facility and user A is an employee, user A may have a user account saved with the language information that is accessible to the spoken language localization system. If user A, such as a customer or a facility associate speaks more than one language, for example, languages X and Y, these two languages may be listed in a user's profile or account. When the user A logs into the mobile computing device such as, but not limited to, a smartphone, tablet or other mobile device equipped with a processor device, the applications executed on the mobile computing device are displayed and interact in one of the two languages X and Y spoken by the facility associate. For example, the interface and the content of the applications may be in language X. When another individual is in the proximity of the mobile computing device and audio sensors, either located in the facility or in the mobile computing device detect a language other than X, then as described above, the spoken language localization system can identify whether the detected language, for example, language Y, is one of the languages spoken by the user A, and the applications executed on the mobile computing device can be localized in language Y. For example, the spoken language localization system may transmit a command from a remote server to the mobile application executing on the mobile device to switch to language Y. Otherwise, if the detected language is not spoken by the user A, the application will not be localized to the detected language by the spoken language localization system.

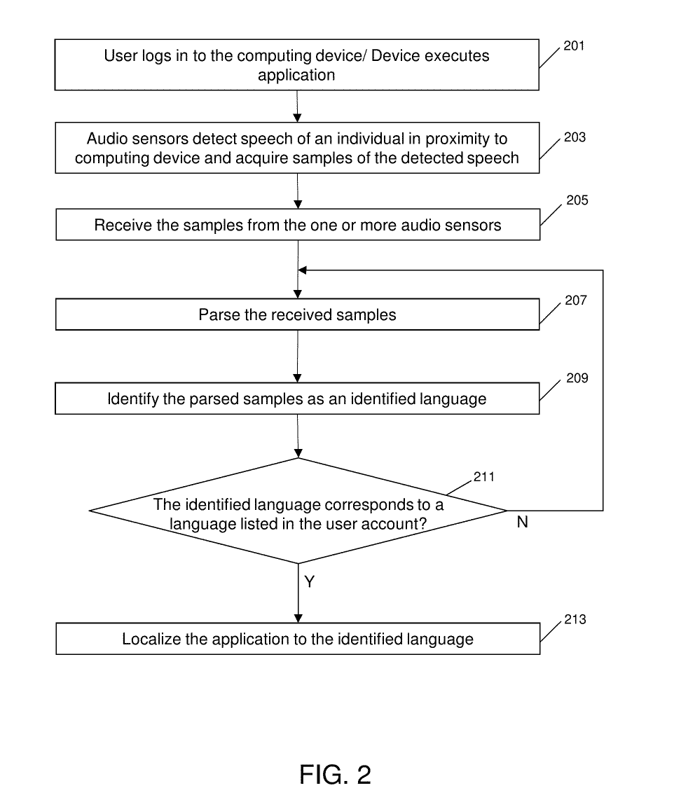

FIG. 2 is a flow diagram illustrating a method performed by a spoken language localization system in accordance with an exemplary embodiment that localizes applications. At step 201, a user, such as a facility associate, logs into a user account of an application executing on the computing device. The user account is associated with user profile that includes information about languages that the user speaks.

In one embodiment, the computing device can receive the identification of the user account via the user inputting and logging in to the computing device. In another embodiment, the computing device can receive the identification of the user account via wireless communication with a device associated with the user. For example, the computing device can be equipped with Near-Field Communication (NFC) readers or Radio-Frequency Identification (RFID) readers, such that the computing device can establish peer-to-peer radio communications and acquire data from another short range communication device, such as a NFC tag or RFID tag associated with the user that includes the language information, by touching the NFC or RFID tag or putting the NFC or RFID tag very close to the computing device. In one non-limiting example, the NFC or RFID tag may be embedded in an employee ID tag.

At step 203, one or more audio sensors detect speech of an opted-in individual in the proximity of the computing device. As described in FIG. 1, in one embodiment, if the computing device is a point-of-sale (POS) device, the audio sensors can be located in a proximity of the POS device, and the audio sensors can detect speech of an individual in the proximity of the POS device. In another embodiment, if the computing device is a mobile device, the audio sensors can be located in the mobile device, such that the audio sensors can detect speech of an individual in the proximity of the mobile device. After detecting the speech, the audio sensors acquire samples of the detected speech, and transmit the acquired samples to a server in the spoken language localization system. The remote server is communicatively coupled to the computing device, the audio sensors and at least a data storage device that holds multiple language databases containing audio samples of different languages and language dialects.

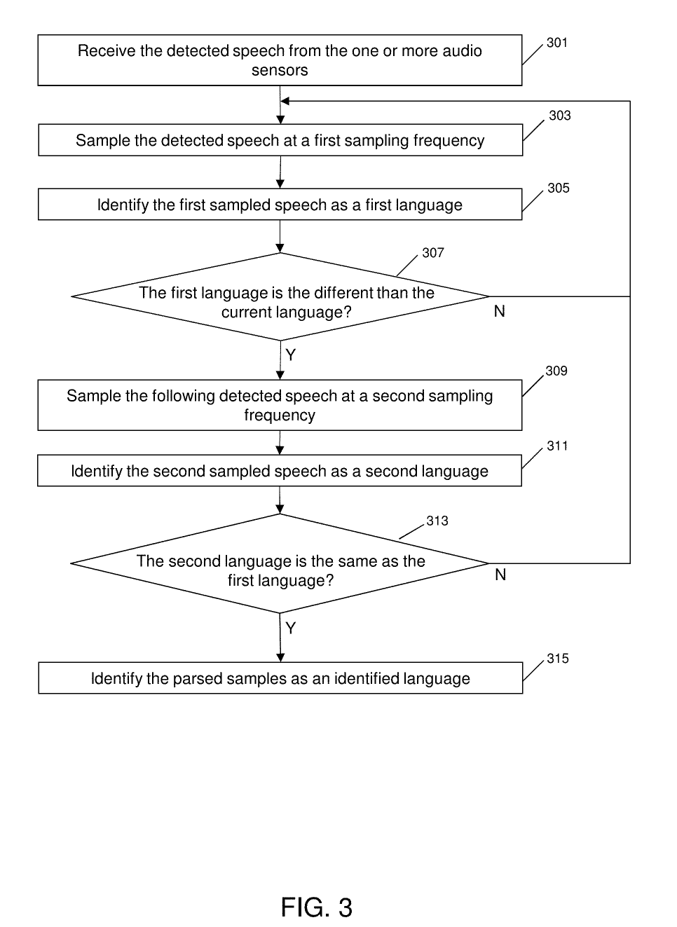

At step 205, the server receives the samples from the one or more audio sensors. The spoken language localization system then parses the received speech samples at step 207. The process of parsing the speech samples will be described in more detail below with regard to FIG. 3.

At step 209, the spoken language localization system identifies the parsed samples as a particular language using the language rules engine and the language databases. In a non-limiting example, the language rules engine may analyze samples using language dictionaries of different languages stored in the language databases to identify the language of the parsed samples. At step 211, the computing system determines whether the identified language corresponds to a language listed in the user account, i.e., whether the identified language is one of the languages that the user speaks. If yes, at step 213, the computing system localizes the application to the identified language on the computing device without user intervention. Otherwise, if at step 211 the computing system determines that the identified language is not one of the languages that the user speaks, the process goes back to step 207 where the system continues to parse the received speech samples.

In another embodiment, the spoken language localization system can further determine whether the detected speech is from the user associated with the user account based on the voice detected by the audio sensors and the user profile in the user account database, and only parses the speech samples that are not from the user associated with the user account, such that the application is only localized in response to detection of unknown individuals.

In this manner, the system can localize the application to an identified language without user intervention based on determining that the identified language is one of the multiple languages that the user speaks that are listed in the user account.

In another embodiment, the application may be localized to an identified language only after a user's consent. For example, after determining that the identified language is one of the multiple languages that the user speaks, the spoken language localization system can query the user via a display generated by the computing device to confirm that the user is agreeable to localizing the application to the identified language.

FIG. 3 is a flow diagram illustrating a method performed by a spoken language localization system in accordance with an exemplary embodiment that parses the speech samples. At step 301, the computing system receives the detected speech from the audio sensors. Then at step 303, the computing system samples the detected speech at a first sampling frequency, and identifies the first sampled speech as a first language, for example, language X at step 305. As noted previously, a rules engine may analyze the samples using language databases to correctly identify the language.

At step 307, the computing system determines whether the first language X is different than the current language of the executed application. If not, for example when, the application is also in language X, the process goes back to step 303 where the computing system continues to sample the next samples of detected speech.

If the detected language X is determined to be different from the current language of the executed application at step 307, to confirm that the user keeps speaking language X, at step 309 the computing system samples the following detected speech at a second sampling frequency which is greater than the first sampling frequency. At step 311 the second sampled speech is identified as a second language.

At step 313 the computing system determines whether the second identified language is the same as the first identified language X. If the languages do not match, the application is not localized to language X and the process goes back to step 303 to sample the next samples of detected speech.

If the second identified language is the same as the first identified language X, the spoken language localization system confirms that the user is speaking language X, and at step 315 the parsed samples are identified as language X and the application will be localized to language X accordingly.

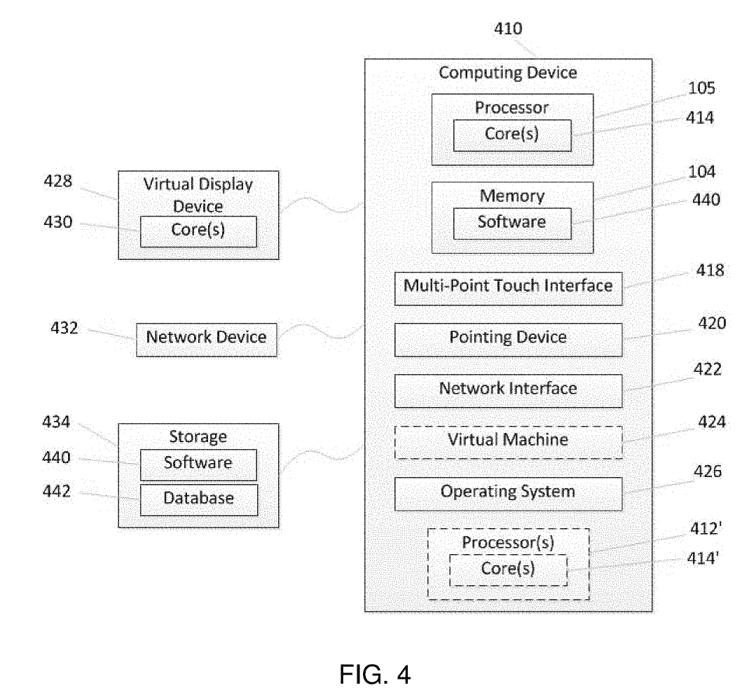

FIG. 4 is a block diagram of an exemplary computing device 410 such as can be used, or portions thereof, in accordance with various embodiments and, for clarity, refers back to and provides greater detail regarding various elements of the system 100 of FIG. 1. The computing device 410, which can be, but is not limited to the server, user mobile device, POS device and data capture devices described herein, can include one or more non-transitory computer-readable media for storing one or more computer-executable instructions or software for implementing exemplary embodiments. The non-transitory computer-readable media can include, but is not limited to, one or more types of hardware memory, non-transitory tangible media (for example, one or more magnetic storage disks, one or more optical disks, one or more flash drives), and the like. For example, memory 104 included in the computing device 410 can store computer-readable and computer-executable instructions or software for performing the operations disclosed herein. For example, the memory 104 can store a software application 440 which is configured to perform the disclosed operations (e.g., localize applications executable on a computing device). The computing device 410 can also include configurable and/or programmable processor 105 and an associated core 414, and optionally, one or more additional configurable and/or programmable processing devices, e.g., processor(s) 412′ and associated core(s) 414′ (for example, in the case of computational devices having multiple processors/cores), for executing computer-readable and computer-executable instructions or software stored in the memory 104 and other programs for controlling system hardware. Processor 105 and processor(s) 412′ can each be a single core processor or multiple core (414 and 414′) processor.

Virtualization can be employed in the computing device 410 so that infrastructure and resources in the computing device can be shared dynamically. A virtual machine 424 can be provided to handle a process running on multiple processors so that the process appears to be using only one computing resource rather than multiple computing resources. Multiple virtual machines can also be used with one processor.

Memory 104 can include a computational device memory or random access memory, such as DRAM, SRAM, EDO RAM, and the like. Memory 104 can include other types of memory as well, or combinations thereof.

A user can interact with the computing device 410 through a visual display device 428, such as any suitable device capable of rendering texts, graphics, and/or images including an LCD display, a plasma display, projected image (e.g. from a Pico projector), Google Glass, Oculus Rift, HoloLens, and the like, and which can display one or more user interfaces 430 that can be provided in accordance with exemplary embodiments. The computing device 410 can include other I/O devices for receiving input from a user, for example, a keyboard or any suitable multi-point touch (or gesture) interface 418, a pointing device 420 (e.g., a mouse). The keyboard 418 and the pointing device 420 can be coupled to the visual display device 428. The computing device 410 can include other suitable conventional I/O peripherals.

The computing device 410 can also include one or more storage devices 434, such as a hard-drive, CD-ROM, flash drive, or other computer readable media, for storing data and computer-readable instructions and/or software that perform operations disclosed herein. In some embodiments, the one or more storage devices 434 can be detachably coupled to the computing device 410. Exemplary storage device 434 can also store one or more software applications 440 for implementing processes of the spoken language localization system described herein and can include databases 442 for storing any suitable information required to implement exemplary embodiments. The databases can be updated manually or automatically at any suitable time to add, delete, and/or update one or more items in the databases. In some embodiments, at least one of the storage device 434 can be remote from the computing device (e.g., accessible through a communication network) and can be, for example, part of a cloud-based storage solution.

The computing device 410 can include a network interface 422 configured to interface via one or more network devices 432 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 422 can include a built-in network adapter, network interface card, PCMCIA network card, card bus network adapter, wireless network adapter, USB network adapter, modem or any other device suitable for interfacing the computing device 410 to any type of network capable of communication and performing the operations described herein. Moreover, the computing device 410 can be any computational device, such as a workstation, desktop computer, server, laptop, handheld computer, tablet computer, or other form of computing or telecommunications device that is capable of communication and that has sufficient processor power and memory capacity to perform the operations described herein.

The computing device 410 can run operating systems 426, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or other operating systems capable of running on the computing device and performing the operations described herein. In exemplary embodiments, the operating system 426 can be run in native mode or emulated mode. In an exemplary embodiment, the operating system 426 can be run on one or more cloud machine instances.

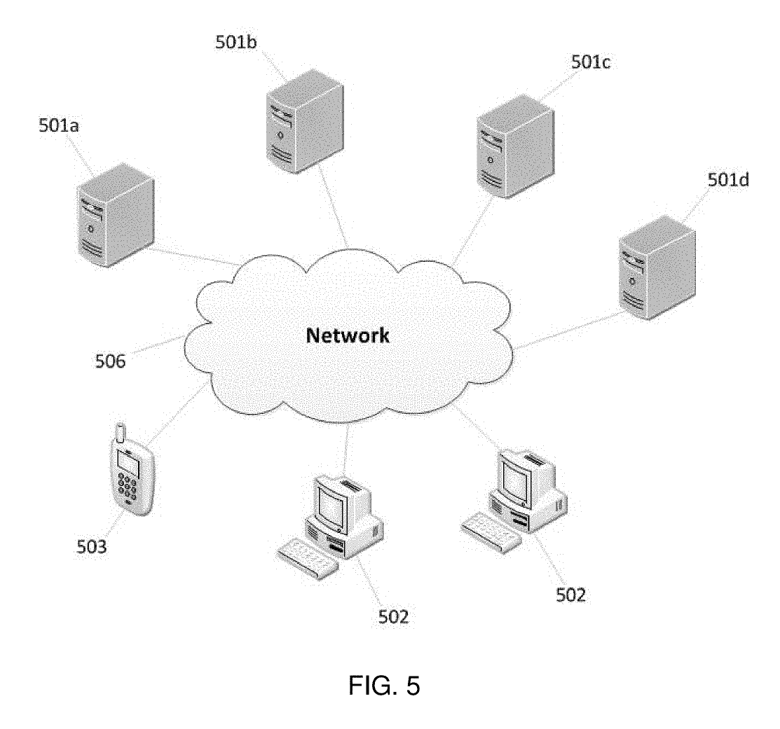

FIG. 5 is a block diagram of exemplary distributed and/or cloud-based embodiments. Although FIG. 1, and portions of the exemplary discussion above, make reference to a spoken language localization system 100 operating on a single computing device, one will recognize that various of the modules within the spoken language localization system 100 may instead be distributed across a network 506 in separate server systems 501a-d and/or in other computing devices, such as a desktop computer device 502, or mobile computer device 503. As another example, the user interface provided by the mobile application 123 can be a client side application of a client-server environment (e.g., a web browser or downloadable application, such as a mobile app), wherein the analysis module 109 is hosted by one or more of the server systems 501a-d (e.g., in a cloud-based environment) and interacted with by the desktop computer device or mobile computer device. In some distributed systems, the modules of the system 100 can be separately located on server systems 501a-d and can be in communication with one another across the network 506

Although the previous discussion has focused on the use of audio sensors to detect speech of an individual as a prelude for language identification of the individual, in another embodiment the spoken language localization system does not rely on audio sensors to detect speech. Instead, an individual, such as a customer of facility, may executed a mobile application associated with the facility on their phone or other mobile device and list different languages with which they are fluent via the mobile application. In one embodiment, the languages may be listed in a preferred order. Upon the individual's approach to a computing device associated with a user, such as a store associate, the mobile application may automatically communicate with the computing device without user assistance to convey the preferred languages to the computing device. The computing device may then communicate with the analysis module to see if there is an overlap between languages the individual is fluent in and languages the user/store associate can read. In the event of an identification of such an overlap, the application on the computing device can be localized so that generated displays and user interfaces appear in the common language.

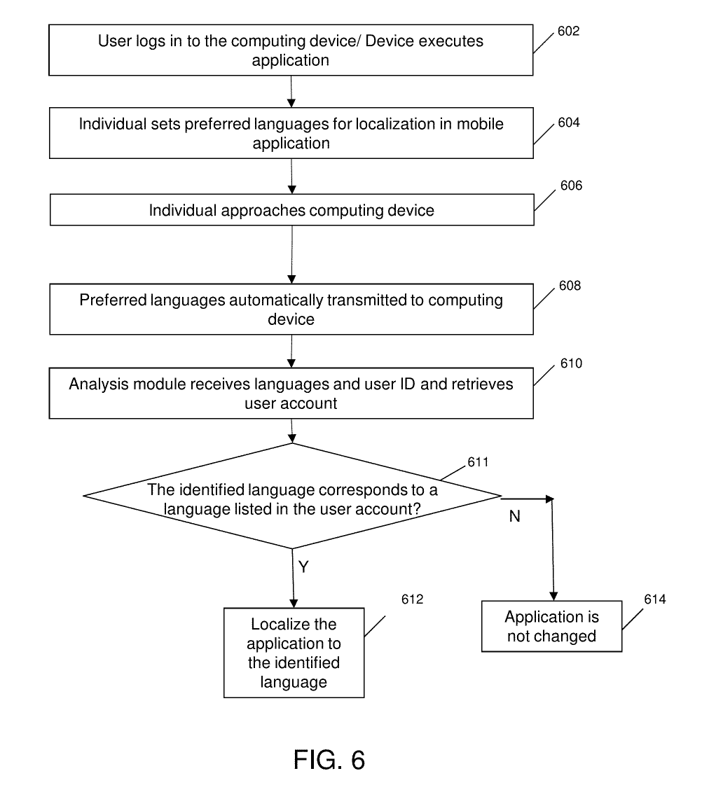

FIG. 6 is a flowchart depicting a sequence for performing application localization in an exemplary embodiment. The sequence begins with, a user of a computing device, such as a facility associate, logging into a user account of an application executing on the computing device (step 602). The user account is associated with user profile that includes information about languages that the user speaks.

In one embodiment, the computing device can receive the identification of the user account via the user inputting and logging in to the computing device. In another embodiment, the computing device can receive the identification of the user account via wireless communication with a device associated with the user. For example, the computing device can be equipped with Near-Field Communication (NFC) readers or Radio-Frequency Identification (RFID) readers, such that the computing device can establish peer-to-peer radio communications and acquire data from another short range communication device, such as a NFC tag or RFID tag associated with the user that includes the language information, by touching the NFC or RFID tag or putting the NFC or RFID tag very close to the computing device. In one non-limiting example, the NFC or RFID tag may be embedded in an employee ID tag.

An individual enters preferred languages for localization (languages with which the individual is fluent) into a mobile application associated with the facility (step 604). It will be appreciated that steps 602 and 604 of the sequence could be performed in reverse order.

When the individual approaches the computing device (step 606), the mobile application communicates with the computing device (e.g. using wireless communication capabilities of the phone/mobile device executing the mobile application) and automatically transfers the individual's preferred languages to the computing device (step 608). The analysis module receives the user ID and the preferred languages from the computing device and retrieves the user account information corresponding to the user ID (step 610). It should be appreciated that in another embodiment, the computing device and mobile device may independently transmit this information to the server executing the analysis module instead of both sets of data being funneled through the computing device. After retrieving the user account, the analysis module determines whether there is an overlap between the languages with which the user is conversant and the individual's preferred languages (step 611). If a common language is identified, and the computing device's application is not currently producing output in that language, the application on the computing device is localized to the identified language (step 612). If a common language is not identified, the application is not changed.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with a multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A spoken language localization system for localizing applications, the system comprising:
an application executable on a computing device equipped with a processor, the application when executed receiving an identification of a user account of a user of the computing device, the user account listing one or more different languages spoken by the user;
a data storage device holding a plurality of language databases containing audio samples of different languages;
one or more audio sensors configured to detect speech of an opted-in individual in the proximity of the computing device and to acquire samples of the detected speech;
a computing system that includes a language rules engine, the computing system communicatively coupled to the computing device, the audio sensors and the data storage device and configured to execute an analysis module that when executed:
receives the samples from the one or more audio sensors;
parses the samples,
identifies the parsed samples as an identified language using the language rules engine and at least one of the plurality of language databases;
determines whether the identified language corresponds to a language listed in the user account; and
localizes the application to the identified language on the computing device without user intervention based on determining that the identified language corresponds to one of the one or more different languages listed in the user account.

2. The system of claim 1 wherein the plurality of language databases includes audio samples of different language dialects.

3. The system of claim 1 wherein the computing device is a point-of-sale device.

4. The system of claim 1 wherein the computing device receives the identification of the user account via the user logging in to the computing device.

5. The system of claim 1 wherein the computing device receives the identification of the user account via wireless communication with a device associated with the user.

6. A spoken language localization system for localizing mobile applications, the system comprising:
a mobile application executable on a mobile computing device equipped with a processor, the mobile application when executed receiving an identification of a user account of a user of the mobile computing device, the user account listing one or more different languages spoken by the user;
a data storage device holding a plurality of language databases containing audio samples of different languages;
one or more audio sensors configured to detect speech of an opted-in individual in the proximity of the mobile computing device and to acquire samples of the detected speech; and
a computing system including a language rules engine, the computing system communicatively coupled to the mobile computing device, the audio sensors and the data storage device and configured to execute an analysis module that when executed:
receives the samples from the one or more audio sensors;
parses the samples,
identifies the parsed samples as an identified language using the language rules engine and at least one of the plurality of language databases;
determines whether the identified language corresponds to a language listed in the user account; and
localizes the mobile application to the identified language on the mobile computing device without user intervention based on determining that the identified language corresponds to one of the one or more different languages listed in the user account.

7. The system of claim 6 wherein the plurality of language databases includes audio samples of different language dialects.

8. The system of claim 1, wherein the one or more audio sensors are located in the mobile device.

9. The system of claim 1 wherein the mobile computing device receives the identification of the user account via the user logging in to the mobile computing device.

10. The system of claim 1 wherein the mobile computing device receives the identification of the user account via wireless communication with a device associated with the user.

11. A computer-implemented method for localizing applications, comprising:
executing an application on a computing device equipped with a processor, the application receiving an identification of a user account of a user of the computing device, the user account listing one or more different languages spoken by the user;
detecting, using one or more audio sensors, speech of an opted-in individual in the proximity of the computing device;
acquiring samples of the detected speech with the one or more audio sensors;
receiving, at a computing system, the samples from the one or more audio sensors;
parsing the samples with the computing system;
identifying the parsed samples as an identified language using a language rules engine in the computing system and at least one of a plurality of language databases, the plurality of language databases containing audio samples of different languages;
determining with the computing system whether the identified language corresponds to a language listed in the user account; and
localizing the application to the identified language on the computing device without user intervention based on determining that the identified language corresponds to the language listed in the user account.

12. The method of claim 11 wherein the plurality of language databases includes audio samples of different language dialects.

13. The method of claim 11 wherein the computing device is a point-of-sale device.

14. The method of claim 11 wherein the computing device receives the identification of the user account via the user logging in to the computing device.

15. The method of claim 11 wherein the computing device receives the identification of the user account via wireless communication with a device associated with the user.

16. A computer-implemented method for localizing mobile applications, comprising:
executing a mobile application on a mobile computing device equipped with a processor, the mobile application receiving an identification of a user account of a user of the mobile computing device, the user account listing one or more different languages spoken by the user;
detecting, using one or more audio sensors, speech of an opted-in individual in the proximity of the mobile computing device;
acquiring samples of the detected speech with the one or more audio sensors;
receiving, at a computing system, the samples from the one or more audio sensors;
parsing the samples with the computing system;
identifying the parsed samples as an identified language using a language rules engine in the computing system and at least one of a plurality of language databases, the plurality of language databases containing audio samples of different languages;
determining with the computing system whether the identified language corresponds to a language listed in the user account; and
localizing the mobile application to the identified language on the mobile computing device without user intervention based on determining that the identified language corresponds to the language listed in the user account.

17. The method of claim 16 wherein the plurality of language databases includes audio samples of different language dialects.

18. The method of claim 16, wherein the one or more audio sensors are located in the mobile device.

19. The method of claim 16 wherein the mobile computing device receives the identification of the user account via the user logging in to the mobile computing device.

20. The method of claim 16 wherein the mobile computing device receives the identification of the user account via wireless communication with a device associated with the user.
